(19) United States
(12) Patent Application Publication
(10) Pub. No.: US 2016/0119857 A1
(43) Pub. Date: Apr. 28, 2016

(54) BILATERAL SEARCH ALGORITHM FOR LTE SYSTEM

(71) Applicant: QUALCOMM Incorporated, San Diego, CA (US)

(72) Inventors: Prashanth Mohan, Hyderabad (IN); Aravinth Rajendran, Hyderabad (IN); Parthasarathy Krishnamoorthy, Hyderabad (IN); KrishnaKumar Vasanthasenan, Hyderabad (IN)

(21) Appl. No.: 14/523,105

(22) Filed: Oct. 24, 2014

(51) Int. Cl. H04W 48/16; H04W 72/04

(52) U.S. Cl. CPC H04W 48/16; H04W 72/0453

(57) ABSTRACT

Methods, systems, and devices are described for acquiring a network by a user equipment (UE) by concurrently scanning for a network signal on supported frequencies by two or more antennas. In one aspect, a method may include searching by a first antenna for a first signal on a first group of supported frequencies while concurrently searching by a second antenna for the first signal on a second group of supported frequencies. The method may further include acquiring the first signal from the first antenna on a first frequency, and tuning the second antenna to the first frequency to acquire the wireless network. In one aspect, the first and second groups of supported frequencies may represent frequencies within a single frequency band or frequencies in multiple frequency bands. In one aspect, supported frequencies may be divided into multiple groups and each group may be searched by a corresponding antenna.

### BACKGROUND

1. Field of the Disclosure

The present disclosure, for example, relates to wireless communication systems, and more particularly to acquiring network signals using multiple antennas.

2. Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of base stations, each simultaneously supporting communication for multiple communication devices, otherwise known as user equipments (UEs). A base station may communicate with UEs on downlink channels (e.g., for transmissions from a base station to a UE) and uplink channels (e.g., for transmissions from a UE to a base station).

The process for a UE, such as a multimode device, to acquire a connection with a new wireless network, such as a long term evolution (LTE) or Global System for Mobile (GSM) communications network, consumes resources, including both time and power. In some implementations, a UE may perform a scan of supported frequency bands (e.g., sequentially or based on frequency bands previously resulting in a successful connection) to connect with a new network by searching a single frequency band at a time, regardless of the number of antennas on the UE. This scanning process may take a substantial amount of time, result in high power consumption, and can occupy resources that affect other radio access technology (RAT) performance, for example, affecting GSM communications including paging of the UE when the UE is scanning LTE bands.

### SUMMARY

The described features generally relate to one or more improved systems, methods, and/or apparatuses for acquiring a network by a UE by scanning for a network signal on multiple frequencies concurrently using two or more antennas. In some embodiments, a UE may first determine whether the UE supports multiple frequency bands. If the UE does support multiple frequency bands, the UE may divide the supported frequency bands into any number of groups, for example, according to an index or indexed values. Each indexed frequency band may support one or more frequencies (e.g., EUTRA Absolute Radio Frequency Channel Numbers (EARFCNs)). The UE may then begin scanning for a signal from a network on the supported frequency bands, with frequencies of each group of indexed frequency bands being searched using a different antenna of the UE at the same time. If the UE does not support multiple frequency bands, the UE may group and/or index the supported frequencies and search for each group of frequencies by different antennas concurrently. In this way, frequencies/frequency bands may be searched by the UE to acquire a network more quickly and using less power.

In some embodiments, a method of acquiring a wireless network by a UE may include searching using a first antenna for a first signal on a first group of supported frequencies while concurrently searching by a second antenna for the first signal on a second group of supported frequencies. The UE may acquire the first signal from the first antenna on a first frequency and tune the second antenna to the first frequency to acquire the wireless network. In one aspect, the first signal may include a Primary Synchronization Signal (PSS) periodically transmitted from a base station. The first frequency may include an Evolved Universal Terrestrial Radio Access (EUTRA) Absolute Radio Frequency Channel Number (EARFCN). In some cases, the first and second groups of supported frequencies may represent frequencies within a single frequency band. In other cases, the first and second groups of supported frequencies may represent first and second groups of frequency bands.

In one aspect, the UE may acquire the first signal from the second antenna on a second frequency and store the second frequency in a memory of the UE. The UE may subsequently access the second frequency from the memory and tune both the first antenna and the second antenna to the second frequency to acquire the wireless network, for example, when acquisition on the first frequency fails. In some cases, the UE may acquire the first signal from the first antenna concurrently with acquiring the first signal from the second antenna.

In one aspect, the UE may divide a plurality of supported frequencies into a plurality of groups and search each of the plurality of groups using a corresponding antenna (e.g., with the number of groups corresponding to the number of antennas implemented on the UE).

In some embodiments, the UE may index a plurality of supported frequencies. The UE may then assign a first portion of the indexed frequencies to the first group and assign a second portion of the indexed frequencies to the second group. The UE may assign the first and the second portions of the indexed frequencies to the first group and the second group based on random selection, the indexing of the frequencies, frequency characteristics, or a combination of these and any other organizational schemes.

In some embodiments, a UE apparatus for wireless communication may include means for searching by a first antenna for a first signal on a first group of supported frequencies while concurrently searching by a second antenna for the first signal on a second group of supported frequencies. The apparatus may further include means for acquiring the first signal from the first antenna on a first frequency, and means for tuning the second antenna to the first frequency to acquire the wireless network. In some cases, the first and second groups of supported frequencies may represent frequencies within a single frequency band. In other cases, the first and second groups of supported frequencies may represent first and second groups of frequency bands.

In one aspect, the apparatus may further include means for acquiring the first signal from the second antenna on a second frequency and means for storing the second frequency in a memory of the UE. In some implementations, the apparatus may include means for accessing the second frequency from the memory of the UE and means for tuning both the first antenna and the second antenna to the second frequency to acquire the wireless network if acquisition on the first frequency fails. In yet some implementations, the means for acquiring the first signal from the first antenna and the means for acquiring the first signal from the second antenna may include means for concurrent acquisition.

In some embodiments, the apparatus may include means for indexing a plurality of supported frequencies. The apparatus may additionally include means for assigning a first portion of the indexed frequencies to the first group and means for assigning a second portion of the indexed frequencies to the second group. In some cases, the means for assigning the first and the second portions of the indexed frequencies to the first group and the second group may be based on at least one of random selection, the indexing of the frequencies, frequency characteristics, or a combination thereof.

In some embodiments, a UE apparatus for wireless communication may include a processor, a memory in electronic communication with the processor, and instructions stored in the memory. The instructions may be executable by the processor to search by a first antenna for a first signal on a first group of supported frequencies while concurrently searching by a second antenna for the first signal on a second group of supported frequencies. The instructions may be further executable by the processor to acquire the first signal from the first antenna on a first frequency, and tune the second antenna to the first frequency to acquire the wireless network.

In one aspect, the instructions stored in the memory may be further executable by the processor to acquire the first signal from the second antenna on a second frequency, and store the second frequency in the memory. The instructions may be further executable by the processor to access the second frequency from the memory, and tune both the first antenna and the second antenna to the second frequency to acquire the wireless network if acquisition on the first frequency fails. In some cases, the instructions for acquiring the first signal from the first antenna may include instructions for performing the acquisition concurrently with acquiring the first signal from the second antenna.

In some implementations, the instructions stored in the memory may be further executable by the processor to index a plurality of supported frequencies, assign a first portion of the indexed frequencies to the first group, and assign a second portion of the indexed frequencies to the second group. In some cases, the instructions for assigning the first and the second portions of the indexed frequencies to the first group and the second group may be based on at least one of random selection, the indexing of the frequencies, frequency characteristics, or a combination thereof.

In some embodiments, a non-transitory computer-readable medium may store computer-executable code for wireless communication, with the code executable by a processor to search, by a first antenna of a UE, for a first signal on a first group of supported frequencies while concurrently searching by a second antenna for the first signal on a second group of supported frequencies. The code may be further executable by a processor to acquire the first signal from the first antenna on a first frequency and tune the second antenna to the first frequency to acquire the wireless network.

In one aspect, the code may be further executable by a processor to acquire the first signal from the second antenna on a second frequency and store the second frequency in a memory of the UE. In some cases, the code may be further executable by a processor to access the second frequency from the memory and tune both the first antenna and the second antenna to the second frequency to acquire the wireless network if acquisition on the first frequency fails.

In some implementations, the code may be further executable by a processor to index a plurality of supported frequencies, assign a first portion of the indexed frequencies to the first group, and assign a second portion of the indexed frequencies to the second group. In some cases, the code for assigning the first and the second portions of the indexed frequencies to the first group and the second group may be based on at least one of random selection, the indexing of the frequencies, frequency characteristics, or a combination thereof.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram of a wireless communication system, in accordance with various aspects of the present disclosure;

FIG. 2 shows a diagram of a UE scanning for a signal from a base station using multiple antennas, in accordance with various aspects of the present disclosure;

FIGS. 3A and 3B show block diagrams of frequency indices used in searching for a network signal, in accordance with various aspects of the present disclosure;

FIG. 4 shows a diagram of a UE scanning for a signal from a base station by using a first antenna to search a first group of frequency indices and a second antenna to search a second group of frequency indices, in accordance with various aspects of the present disclosure;

FIG. 5 shows a flow diagram of communications between a base station and a UE acquiring a signal from the base station, in accordance with various aspects of the present disclosure;

FIG. 6 shows a block diagram of a device configured for concurrently scanning for a network signal on multiple frequencies using multiple antennas, in accordance with various aspects of the present disclosure;

FIG. 7 shows a block diagram of another device configured for concurrently scanning for a network signal on multiple frequencies using multiple antennas, in accordance with various aspects of the present disclosure;

FIG. 8 shows a block diagram of an apparatus for concurrently scanning for a network signal on multiple frequencies using multiple antennas, in accordance with various aspects of the present disclosure;

FIG. 9 shows a block diagram of a multiple-input/multiple-output communication system, in accordance with various aspects of the present disclosure; and

FIGS. 10, 11A, and 11B show flow charts illustrating examples of methods for concurrently scanning for a network signal on multiple frequencies using multiple antennas, in accordance with various aspects of the present disclosure.

### DETAILED DESCRIPTION

The described features generally relate to one or more improved systems, methods, and/or apparatuses for acquiring a network by a UE by scanning multiple frequencies concurrently using two or more antennas. In one aspect, the UE may divide the supported frequencies (e.g., EUTRA Absolute Radio Frequency Channel Numbers (EARFCNs)) into two or more groups. In some examples, the UE may support multiple frequency bands and may divide the frequencies according to frequency band. The grouping may additionally or alternatively be based on various organization schemes, such as index numbering (even and odd), random ordering, frequency characteristics, etc. The UE may assign each group of frequencies to an antenna utilized by the UE. The UE may then begin scanning on the odd frequency bands, for example, by a first antenna and on the even frequency bands by a second antenna. Once one of the first or second antennas acquires a network signal (e.g., a Primary Synchronization Signal (PSS)), for example on a first frequency, the UE may tune the other antenna to the same first frequency, thus improving signal diversity for better signal reception, and carry out the standard procedures to acquire the network. In the event the network acquisition fails, the UE may resume scanning on both antennas according to the grouping/indexing previously utilized. It should be understood that any number of groups of frequency bands may be implemented, divided according to any organizational scheme, for example, to correspond to the number of antennas supported by the UE to increase the benefits (e.g., reduced network acquisition time and reduced power consumption) described herein.

In some implementations, the UE may receive a PSS on both a first frequency and a second frequency, via the first and second antennas. In this case, the UE may store one of the frequency values in a memory of the UE (e.g., a cache memory), such as the second frequency value, and tune both antennas to the first frequency value to complete the network acquisition. In the event network acquisition fails, the UE may then access the stored frequency value (e.g., the second frequency value searched by the second antenna), tune both antennas to the stored frequency value, and perform network acquisition without having to initiate the searching process again.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

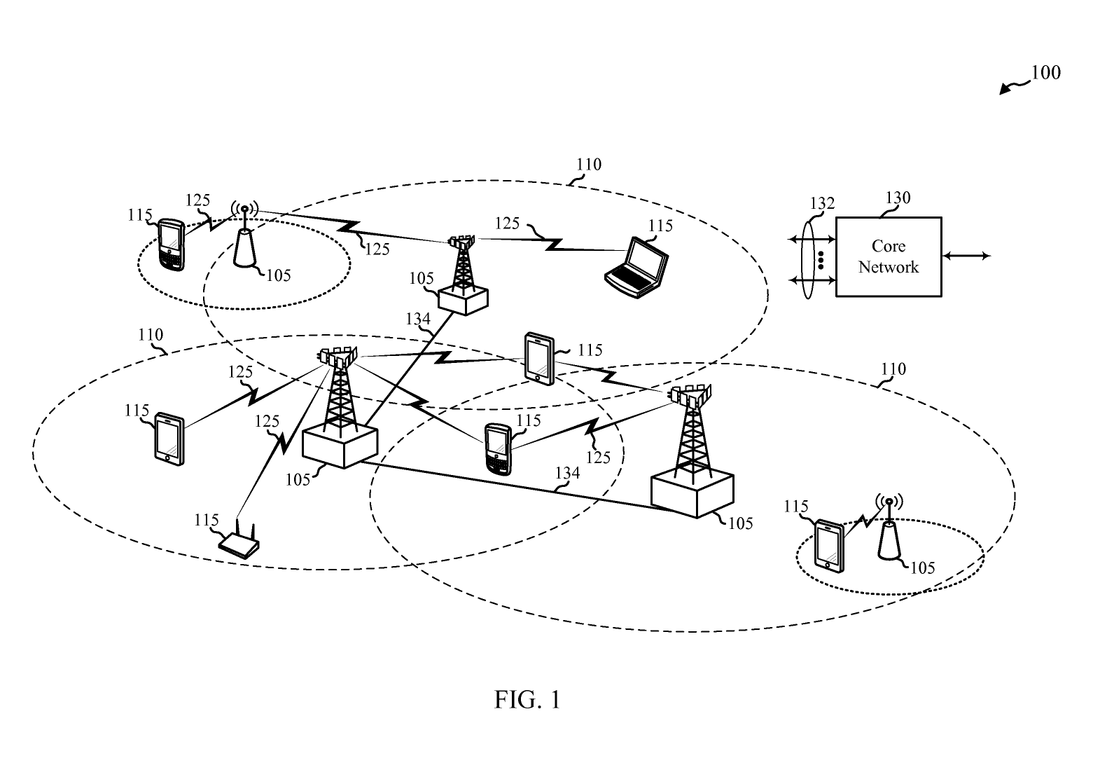

FIG. 1 illustrates an example of a wireless communications system 100 in accordance with various aspects of the disclosure. The wireless communications system 100 includes base stations 105, UEs 115, and a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. Each of the base station 105 sites may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up a portion of the coverage area (not shown). The wireless communications system 100 may include base stations 105 of different types (e.g., macro and/or small cell base stations). There may be overlapping geographic coverage areas 110 for different technologies.

In some examples, the wireless communications system 100 is a 3GPP Long Term Evolution (LTE) or LTE-Advanced (LTE-A) network. In LTE/LTE-A networks, the term evolved Node B (eNB) may be generally used to describe the base stations 105, while the term UE may be generally used to describe the UEs 115. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARD) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network 130 supporting radio bearers for the user plane data. At the Physical (PHY) layer, the transport channels may be mapped to Physical channels.

The UEs 115 are dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment including macro eNBs, small cell eNBs, relay base stations, and the like.

The communication links 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined.

In some embodiments of the system 100, base stations 105 and/or UEs 115 may include multiple antennas for employing antenna diversity schemes to improve communication quality and reliability between base stations 105 and UEs 115. Additionally or alternatively, base stations 105 and/or UEs 115 may employ multiple-input, multiple-output (MIMO) techniques that may take advantage of multi-path environments to transmit multiple spatial layers carrying the same or different coded data.

In some embodiments, a UE 115 may attempt to acquire a signal, and hence establish a link 125 with base station 105, from system 100 by scanning for a network signal periodically transmitted by any of base stations 105. In some instances, the UE 115 may not immediately acquire the signal and consume excess resources, such as power used in the scanning process, while expending time and thus degrading the end user experience. The process of acquiring the signal may further be delayed and/or frustrated by interference from other communications links 125 involving other UEs 115 trying to acquire the system 100, etc.

In current implementations, the UE 115 may scan on supported frequencies for the network signal one frequency at a time, regardless of the number of antennas supported by UE 115. This may include performing a band scan by sweeping across the entire supported band(s) of frequencies to find a suitable band. Current techniques may also include performing a system scan including scanning first for frequencies that previously resulted in network acquisition, and then scanning other supported frequencies if necessary, one frequency at a time. In cases where the UE 115 has multiple antennas, the multiple antennas may each be tuned to the same frequency during scanning.

According to the present disclosure, the resources consumed in the network acquisition process by a UE 115 may be reduced by concurrently scanning on multiple frequency bands by multiple antennas of the UE 115.

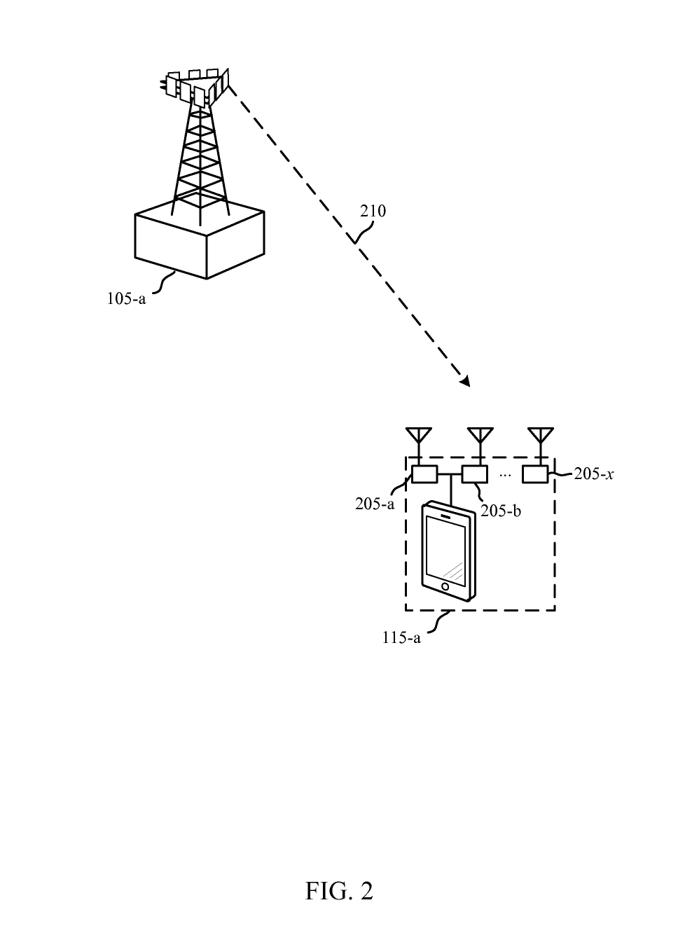

Referring now to FIG. 2, a wireless communication system 200 is illustrated. In the wireless communication system 200, a UE 115-a is attempting to acquire a signal 210 (e.g., a PSS) from a base station 105-a. System 200, UE 115-a, and/or base station 105-a may be examples of system 100, UE 115, and/or base station 105, respectively, described above in reference to FIG. 1.

The UE 115-a may implement any number of antennas 205, such as 205-a, 205-b through 205-x that may be independently controlled and capable of searching for signals and communicating on different supported frequencies of the UE 115-a. To improve the network acquisition process (e.g., reduce time and resources utilized in the process), the UE 115-a may divide the supported frequencies and/or frequency bands into different groups, with the number of groups corresponding to the number of supported antennas 205. The UE 115-a may then direct each antenna 205 to concurrently scan for a network signal, such as a PSS 210, which may be transmitted by base station 105-a periodically. In other words, the UE 115-a may scan for PSS 210 on multiple different frequencies at the same or approximately the same time.

By scanning on multiple different frequencies concurrently, the UE 115-a may reduce the time taken to acquire the PSS 210 by a factor corresponding to the number of antennas 205 of the UE 115-a. In this way, power consumption may be reduced for the UE 115-a as the time expended to acquire the PSS 210 may be significantly reduced. In addition, by potentially utilizing antennas 205 for less time in the network acquisition process, interference with other radios utilizing other radio access technologies implemented on UE 115-a may also be reduced, thus improving overall communication performance of the UE 115-a.

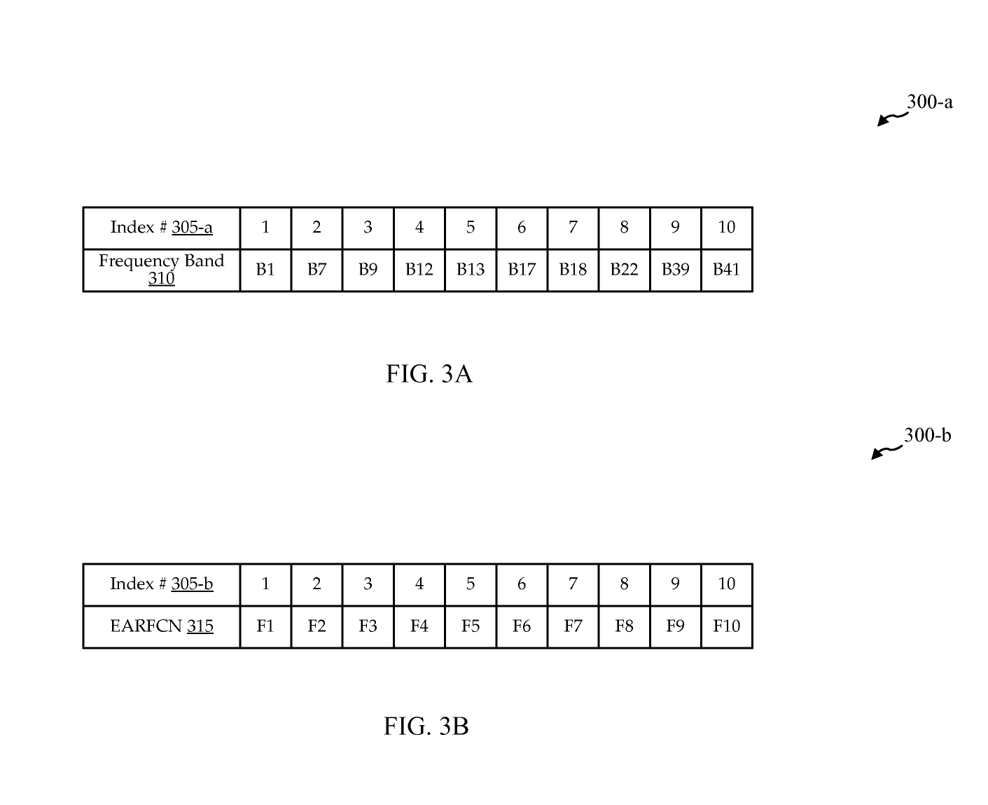

Referring now to FIGS. 3A and 3B, block diagrams of frequency indices 300-a and 300-b that may be used for network acquisition are shown. Frequency indices 300-a and 300-b may correspond to groups of frequencies or frequency bands used for scanning for a network signal as described above in reference to FIGS. 1 and/or 2. In particular, a UE 115, as described above, may determine supported frequencies for scanning and index the supported frequencies by index number according to frequency index 300-a or 300-b. The UE 115 may then divide the index numbers into groups and assign each group to a corresponding antenna to perform the scan for a network signal (e.g., the PSS 210 of FIG. 2).

In some embodiments, the UE may support multiple frequency bands 310. In this scenario, the UE 115 may index the supported frequency bands 310 by index number 305-a. In some cases, the frequency bands 310 may be indexed in ascending order, as illustrated, with band 1 (B1) corresponding to index number 1, B7 corresponding to index number 2, B9 corresponding to index number 3, B12 corresponding to index number 4, B13 corresponding to index number 5, and so on. It should be appreciated that the indexing scheme illustrated in FIG. 3A is given only as an example. Other indexing schemes are contemplated herein, such as ordering the supported frequency bands in various other orders (e.g., random, descending, by a quality metric associated with the frequency band, and so on). Each frequency band 310 may support multiple frequencies, for example, that are associated with EARFCNs. Accordingly, by frequency index 300-a, each index number may correspond to multiple frequencies to be searched.

In some embodiments, the UE 115 may support frequencies in a single frequency band 310. In this scenario, the UE 115 may index each supported frequency by index number 305-b corresponding to an EARFCN 315. As illustrated, each EARFCN 315 may be represented by a frequency number (e.g., F1-F10) and be arranged in ascending order corresponding to index numbers 305-b 1-10. As similarly described above, other techniques of indexing, such as orderings of EARFCNs 315 and/or index numbers 305-b are contemplated herein. For example, the indexing may be performed dynamically, such as to adapt the indexing to changing network and/or channel conditions, may be in part dynamic (e.g., to adapt to certain changes in the network or channel conditions), may be implementation specific, etc.

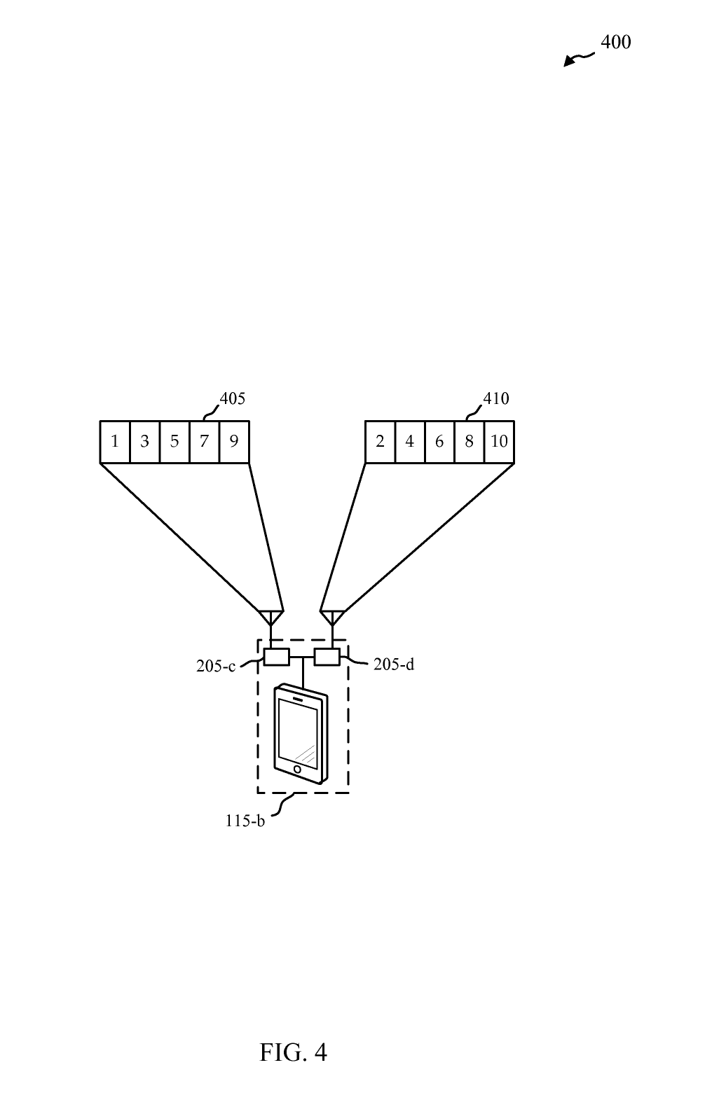

Referring now to FIG. 4, a block diagram 400 of a UE 115-c scanning for a signal from a base station 105 using two antennas is shown. UE 115-b may be an example of one or more aspects of UE 115 described above in reference to FIGS. 1, and/or 2. UE 115-b may include a first antenna 205-c and a second antenna 205-d, which may similarly be an example of one or more aspects of antennas 205 described above in reference to FIG. 2.

The UE 115-b may attempt to acquire a network signal, for example PSS 210 of FIG. 2, by scanning on multiple frequencies with first and second antennas 205-c and 205-d. In some embodiments, the UE 115-b may index all of the supported frequencies on which the UE 115-b can scan, for example, according to frequency index 300-a or 300-b described above in reference to FIGS. 3A and 3B. The UE 115-a may then divide the index numbers into two groups, 405 and 410, with group 405 including all of the frequencies corresponding to odd index numbers and group 410 including all of the even index numbers. The UE 115-a may then direct antenna 205-c to scan for a network signal on frequencies corresponding to index numbers 1, 3, 5, 7, and 9, for example, in that order or in another order. Concurrently, the UE 115-b may direct antenna 205-d to scan for a network signal on frequencies represented by index numbers 2, 4, 6, 8, and 10, in that or another order. In this way, the UE 115-b may scan for a network signal using both antennas 205-c and 205-d at the same or relatively the same time on different frequencies.

It should be appreciated that the indexing scheme and grouping of indices described above is given only by way of example. Other grouping and/or association schemes between index numbers and antennas is contemplated herein. Furthermore, any number of antennas may be implemented by UE 115-b, concurrently scanning for a network signal on corresponding groups of frequencies and/or frequency bands.

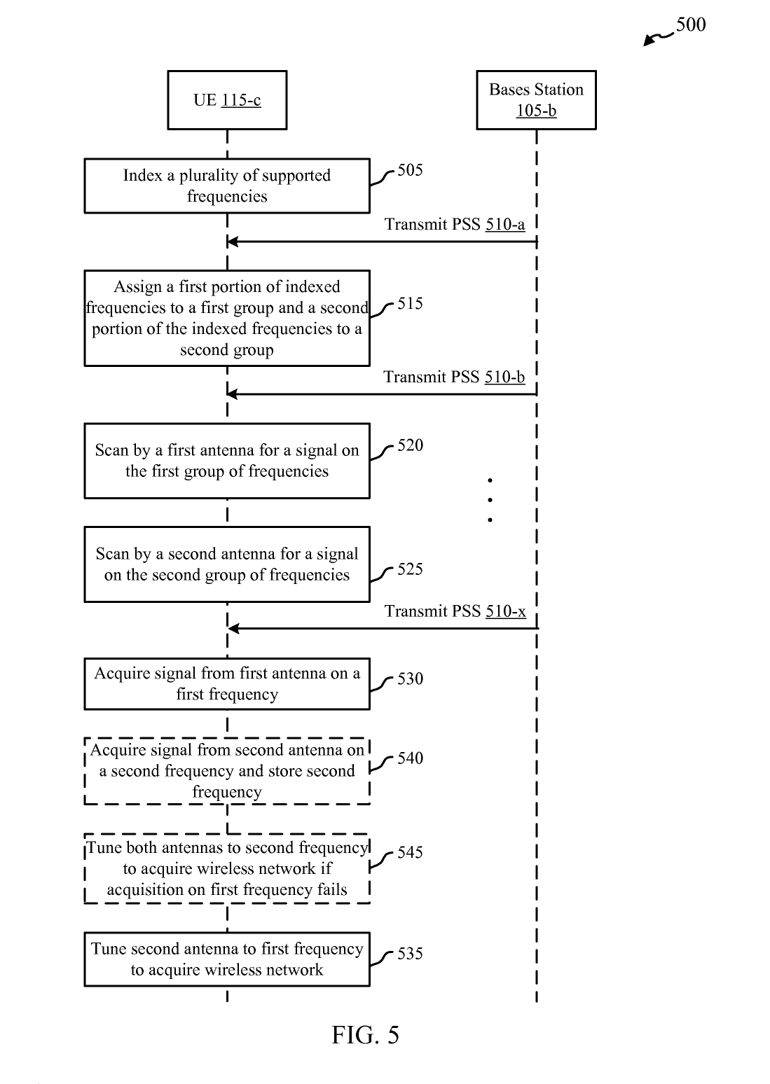

Referring now to FIG. 5, a flow diagram of communications 500 between a base station 105- and a UE 115-c acquiring a signal from the base station 105-a is shown. UE 115-c and/or base station 105-b may be examples of one or more aspects of UE 115 and/or base station 105, respectively, described above in reference to FIGS. 1, 2, and/or 4, and/or may be a part of systems 100 and/or 200 described above in reference to FIGS. 1 and/or 2.

The UE 115-c may first index a plurality of supported frequencies or frequency bands at 505, such as according to frequency indices 300-a or 300-b described above in reference to FIGS. 3A and 3B. The UE 115-c may then assign a first portion of the indexed frequencies/frequency bands to a first group and a second portion to a second group at 515. In some cases, the grouping of frequencies/frequency bands may be done by index number. In other cases, supported frequencies/frequency bands may be grouped randomly, according to one or more metrics of channel quality associated with each frequency/frequency band, or the like. Two groups of frequencies corresponding to two antennas are described herein for ease of reference; however, it should be appreciated that other numbers of groups, corresponding to antennas on the UE 115-c, are contemplated herein.

In some cases, during the time the UE 115-c is indexing/grouping supported frequencies, the base station 105-b may periodically transmit a PSS (e.g., PSS 210 of FIG. 2) at 510. In some cases, the base station 105-b may broadcast the PSS twice during every radio frame, which when received by the UE 115-c, may enable the UE 115-c to acquire the slot boundary of the base station 105-b and establish a communication link (e.g., communication link 125 of FIG. 1) with the base station 105-b. In one example, the base station 105-b may transmit the PSS at 510-a after the UE 115-c has performed the indexing at 505, at 510-b after the UE 115-e has assigned the supported frequencies to groups at 515, and so on.

After indexing at 505 and grouping at 515, the UE 115-c may instruct a first antenna, such as antenna 205-c of FIG. 4, to search for the PSS on the first group of frequencies at 520. Concurrently, the UE 115-c may instruct a second antenna, such as antenna 205-d of FIG. 4, to search for the PSS on the second group of frequencies at 525.

Meanwhile, the base station 105-b may continue to transmit the PSS, for example at 510-x. The UE 115-c may, upon scanning on the first and second groups of frequencies by the first and second antennas, acquire/receive the PSS on a first frequency, for example, searched by the first antenna at 530. The UE 115-c may then direct the second antenna to scan on the first frequency to provide diversity for better reception of the PSS and acquire the network at 535.

In some cases, the PSS may be acquired by the second antenna on a second frequency concurrently with the acquisition by the first antenna on a first frequency. In this scenario, the UE 115-a may store the second frequency in a memory of the UE 115-a at 540. In the event that acquisition on the first frequency fails, the UE 115-a may tune the first and second antennas to the second frequency to acquire the network at 545. In this way, if the first acquisition fails, a second acquisition may be performed without requiring the execution of the full scanning procedure. In some cases, the UE 115-c may dynamically select the order of acquisition on either first or second frequency depending upon the signal strength of the PSS seen by both antennas.

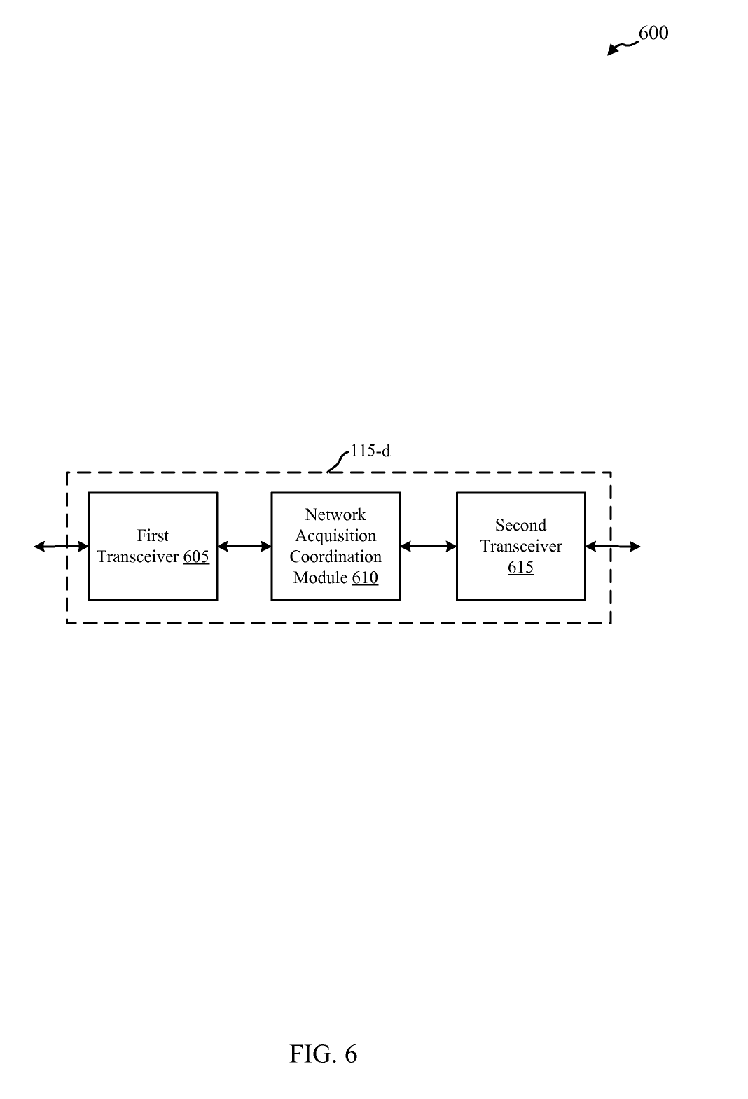

FIG. 6 shows a block diagram 600 of a UE 115-d for concurrently scanning for a network signal on multiple frequencies using multiple antennas, in accordance with various aspects of the present disclosure. The UE 115-d may be an example of one or more aspects of UE 115 described with reference to FIGS. 1, 2, 4, and/or 5, may utilize one or more aspects of frequency indices 300-a and/or 300-b of FIGS. 3A and 3B, and/or may scan multiple frequencies for a network signal according to flow diagram 500 of FIG. 5. The UE 115-d may include a first transceiver 605, a network acquisition coordination module 610, and/or a second transceiver 615. The UE 115-d may include a processor (not shown). Each of these modules may be in communication with each other.

The components of the UE 115-d may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each module may also be implemented, in whole or in part, with instructions embodied in a memory, formatted to be executed by one or more general or application-specific processors.

The first and second transceivers 605, 615 may each transmit and receive information such as packets, user data, and/or control information associated with various information channels (e.g., control channels, data channels, etc.). The first and second transceivers 605, 615 may each be configured to scan for and receive one or more messages/signals from one or more base stations 105. In particular, each of the first and second transceivers may scan for and receive a PSS signal from any number of base stations 105, for example, in the process of acquiring a connection with a base station 105/network or system 100, 200. Each of the first and second transceivers 605, 615 may communicate on different frequencies, (e.g., EARFCNs) and/or frequency bands.

In some embodiments, UE 115-d may seek to acquire a connection (e.g., establish communication link 125 of FIG. 1) with a base station 105. The first and/or second transceivers 605, 615 may communicate supported frequency (EARFCN)/frequency band information to the network acquisition coordination module 610. The network acquisition coordination module 610 may determine if multiple frequency bands are supported. If so, the network acquisition coordination module 610 may group and/or index the supported frequency bands into a number of groups corresponding to the number of antennas/transceivers 605, 615 supported by UE 115-d (e.g., using frequency index 300-b of FIG. 3B). In the example shown, the network acquisition coordination module 610 may group the supported frequency bands into two groups, corresponding to the first and second transceivers 605, 615. However, it should be appreciated that any other number of transceivers may be implemented on UE 115-d, whereby the network acquisition coordination module 610 may form a number of frequency band groups corresponding to the number of transceivers. If only one frequency band is supported by the first and second transceivers 605, 615, then the network acquisition coordination module 610 may group the supported frequencies (EARFCNs) into two groups (e.g., using frequency index 300-a of FIG. 3A).

Once the supported frequencies/frequency bands are grouped and/or indexed, the network acquisition coordination module 610 may instruct each of the first and second transceivers 605, 615 to scan for a PSS on the first frequency in the corresponding group of frequencies/frequency bands. The network acquisition coordination module 610 may continue to instruct the first and second transceivers 605, 615 to scan on subsequent frequencies in each group until a PSS is acquired. Upon acquiring a PSS by one of the first and second transceivers 605, 615, the network acquisition coordination module 610 may then direct the other transceiver 605, 615 to tune to the same frequency/EARFCN to increase diversity and enable better signal reception to acquire the desired network connection.

In the event that both of the first and second transceivers 605, 615 acquire a PSS on different frequencies at the same time, the network acquisition coordination module 610 may store one of the frequencies values. The network acquisition coordination module 610 may then instruct both transceivers 605, 615 to tune to the other of the two frequencies to acquire the network. In the event that the first acquisition attempt fails, the network acquisition coordination module 610 may direct both of the first and second transceivers 605, 615 to tune to the stored frequency value to attempt a second acquisition. In this way, time to acquire the network signal may be reduced in the event a first acquisition attempt fails, such as by not necessitating a full search process (e.g., searching for frequencies when another frequency has already been identified).

In some embodiments, the network acquisition coordination module 610 may instruct the first and second transceivers 605, 615 to search for a network signal by communicating frequency group information. In this scenario, the first and second transceivers 605, 615 may perform the steps of searching multiple frequencies/frequency bands without direct control from the network acquisition coordination module 610.

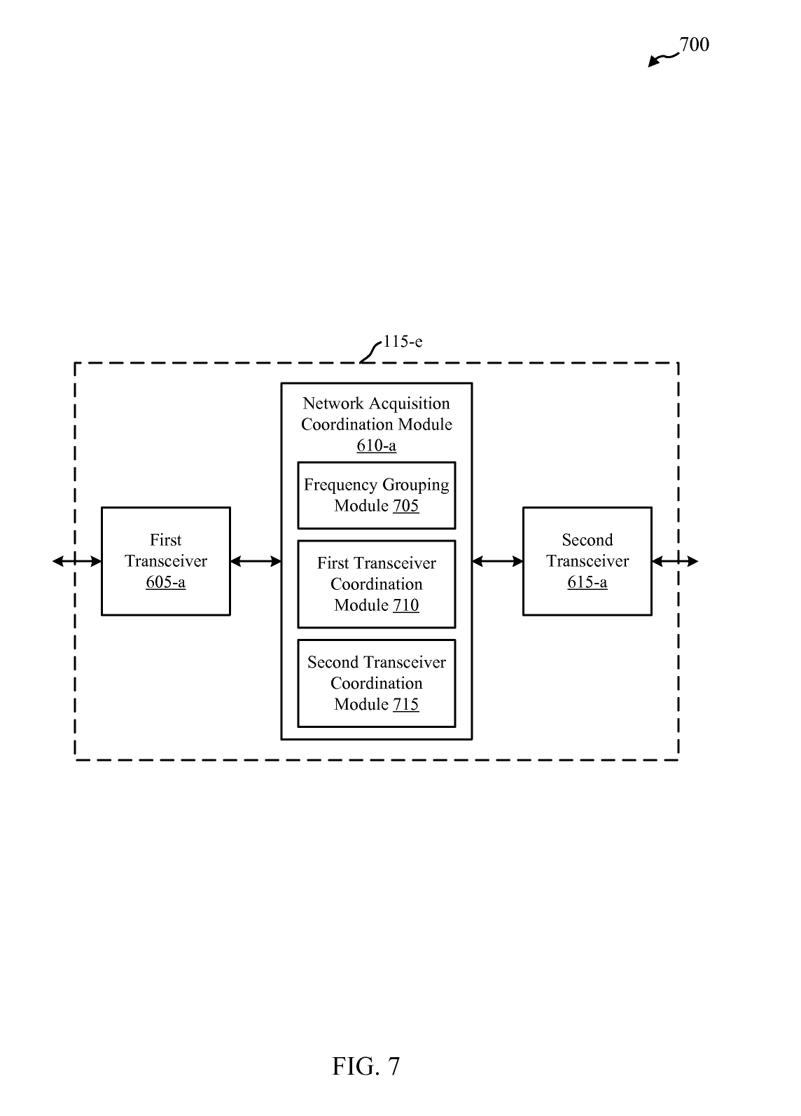

FIG. 7 shows a block diagram 700 of another UE 115-e for concurrently scanning for a network signal on multiple frequencies using multiple antennas, in accordance with various aspects of the present disclosure. The UE 115-e may be an example of one or more aspects of UE 115 described with reference to FIGS. 1, 2, 4, 5, and/or 6, may utilize one or more aspects of frequency indices 300-a and/or 300-b of FIGS. 3A and 3B, and/or may scan multiple frequencies for a network signal according to flow diagram 500 of FIG. 5. The UE 115-e may include a first transceiver 605-a, a network acquisition coordination module 610-a, and/or a second transceiver 615-a. The UE 115-e may also be or include a processor (not shown). Each of these modules may be in communication with each other. The network acquisition coordination module 610-a may further include a frequency grouping module 705, a first transceiver coordination module 710, and a second transceiver coordination module 715. The first transceiver 605-a and the second transceiver 615-a may perform the functions of the first transceiver 605 and the second transceiver 615, of FIG. 6, respectively.

In the process of acquiring a network connection, the network acquisition coordination module 610-a of UE 115-e may receive supported frequency (EARFCN)/frequency band information from the first and second transceivers 605-a, 615-a. The frequency grouping module 705 of the network acquisition coordination module 610-a may then group the supported frequencies/frequency bands into a number of groups corresponding to the number of transceivers 605-a, 615-a of UE 115-e (e.g., two groups as illustrated). In some cases, the frequency grouping module 705 may group two or more supported frequency bands into two different groups and/or may group supported frequencies (EARFCNs) into two different groups, depending on whether multiple frequency bands are supported by UE 115-e.

In some implementations, in conjunction with grouping, the frequency grouping module 705 may index the supported frequencies/frequency bands. In one implementation, the frequency grouping module 705 may index all of the supported EARFCNs/frequency bands and divide the frequencies/frequency bands into two groups, with a first group containing odd index values and a second group containing even index values (e.g., according to frequency index 300-a or 300-b of FIGS. 3A and 3B). In some cases, the grouping/indexing may be performed according to random selection, based on channel characteristics of the supported frequencies/frequency bands, etc. In one example, the first frequency/frequency band to be scanned in each group may correlate to frequencies/frequency bands that experience the least amount of interference, have the best latency, etc., for example based on historical information. The second frequency/frequency band to be scanned in each group may exhibit the next best performance, and so on. It should be appreciated that other channel/frequency characteristic metrics may be used to similar effect.

Upon grouping the supported frequencies/frequency bands, the frequency grouping module 705 may communicate the grouping information to the first and second transceiver coordination modules 710, 715. The first and second transceiver coordination modules 710, 715 may then instruct the first and second transceivers 605-a, 615-a, respectively, to scan for a network signal according to the grouping information. In one example, the first transceiver coordination module 710 may instruct the first transceiver 605-a to scan for a PSS on supported frequencies/frequency bands in the first corresponding index or group (e.g., according to frequency index 300-a or 300-b of FIGS. 3A and 3B, respectively), and the second transceiver coordination module 715 may similarly instruct the second transceiver 615-a to scan for a PSS on the supported frequencies/frequency bands in the second corresponding index or group.

Upon acquiring a network signal on a first and/or second frequency/frequency band, the first and/or second transceivers 605-a, 615-a may indicate the first and/or second frequency/frequency band and communicate the network signal (e.g., PSS) to the corresponding first and/or second transceiver coordination modules 710, 715. In one example, the first transceiver 605-a may acquire a PSS from a base station 105. Upon receiving the PSS/indication of the signal received on a first frequency/frequency band from the first transceiver 605-a, the first transceiver coordination module 710 may then instruct the second transceiver coordination module 715 to tune to the same first frequency/frequency band. Accordingly, the second transceiver coordination module 715 may instruct the second transceiver 615-a to scan on the first frequency/frequency band to better enable signal reception and network acquisition.

In the event both the first and second transceivers 605-a, 615-a receive a network signal at the same time, the network acquisition coordination module 610-a and/or one of the first transceiver or second transceiver coordination module 710, 715, may share the frequency information and coordinate both transceivers 605-a, 615-a to tune to the same frequency/frequency band to attempt network acquisition. If network acquisition fails on the first frequency/frequency band, the network acquisition coordination module 610-a and/or one of the first transceiver or second transceiver coordination modules 710, 715 may coordinate both transceivers 605-a, 615-a to tune to the second frequency/frequency band to reattempt network acquisition.

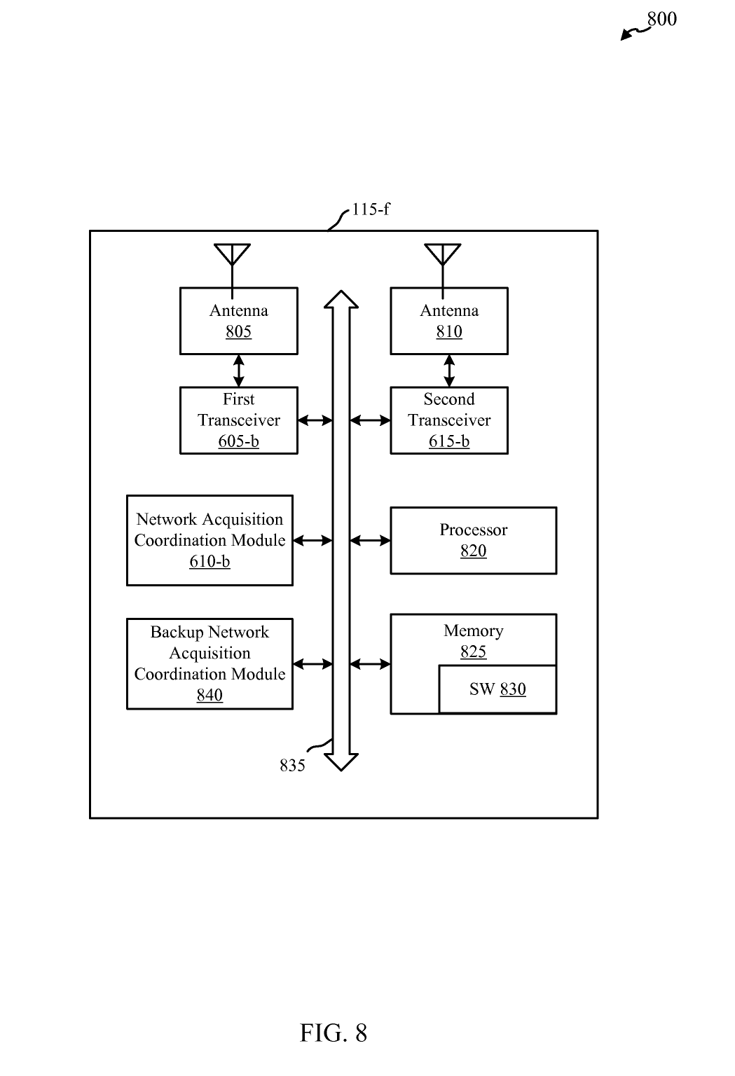

FIG. 8 shows a block diagram 800 of another UE 115-f for concurrently scanning for a network signal on multiple frequencies using multiple antennas, in accordance with various aspects of the present disclosure. The UE 115-f may be an example of one or more aspects of UE 115 described with reference to FIGS. 1, 2, 4, 5, 6, and/or 7, may utilize one or more aspects of frequency indices 300-a and/or 300-b of FIGS. 3A and 3B, and/or may scan multiple frequencies for a network signal according to flow diagram 500 of FIG. 5.

The UE 115-f may generally include components for bi-directional voice and data communications including components for transmitting communications and components for receiving communications. The UE 115-f may include antennas 805, 810, first and second transceivers 605-b, 615-b, a processor module 820, and memory 825 (including software (SW) 830), which each may communicate, directly or indirectly, with each other (e.g., via one or more buses 835). Each of the transceivers 605-b, 615-b may be configured to communicate bi-directionally, via the antennas 805, 810 and/or one or more wired or wireless links, with one or more networks, as described above. For example, the transceivers 605-b, 615-b may be configured to communicate bi-directionally with base stations 105 with reference to FIGS. 1, 2, 4, and/or 5. The transceivers 605-b, 615-b may each include a modem configured to modulate the packets and provide the modulated packets to the antennas 805, 810 for transmission, and to demodulate packets received from the antennas 805, 810. While each transceiver 605-b, 615-b of the UE 115-f may include a single antenna 805, 810, each transceiver 605-b, 615-b may have multiple antennas capable of concurrently transmitting and/or receiving multiple wireless transmissions. Each transceiver 605-b, 615-b may be capable of concurrently communicating with one or more base stations 105 via multiple component carriers.

The UE 115-f may include a network acquisition coordination module 610-b, which may perform the functions of the network acquisition coordination module 610 described above in reference to FIGS. 6 and/or 7. The UE 115-f may also include a backup network acquisition module 840, which may, in conjunction with memory 825, perform a second network acquisition attempt when a first attempt on a first frequency/frequency band fails. In some cases, both of the first and second transceivers 605-b, 615-b/antennas 805,810 may receive a network signal on two different frequencies at the same or relatively the same time. In this scenario, the backup network acquisition module 840 may receive frequency information (e.g., frequency value such as EARFCN, or frequency band value) from each of the first and second transceivers 605-b, 615-b. The backup network acquisition module 840 may store a first frequency value in the memory 825, while the network acquisition coordination module 610-b instructs both of the transceivers 605-b, 615-b to acquire the network connection on the second frequency value. If acquisition on the second frequency value fails, the network acquisition coordination module 610-b may communicate this information to the backup network acquisition module 840. The backup network acquisition module 840 may then retrieve the stored first frequency value from memory 825 and instruct both of the transceivers 605-b, 615-b and/or antennas 805, 810 to scan/acquire the network connection on the first frequency value. In this way, the backup network acquisition module 840 may reduce network acquisition time when a first attempt fails.

The memory 825 may include random access memory (RAM) and read-only memory (ROM). The memory 825 may store computer-readable, computer-executable software/firmware code 830 containing instructions that are configured to, when executed, cause the processor module 820 to perform various functions described herein (e.g., instructing the first and second transceivers 605-b, 615-b and/or the corresponding antennas 805, 810 to concurrently search for a network signal on multiple frequencies/frequency bands, etc.). Alternatively, the computer-readable, computer-executable software/firmware code 830 may not be directly executable by the processor module 820 but be configured to cause a computer (e.g., when compiled and executed) to perform functions described herein. The processor module 820 may include an intelligent hardware device, e.g., a central processing unit (CPU), a microcontroller, an application-specific integrated circuit (ASIC), etc.

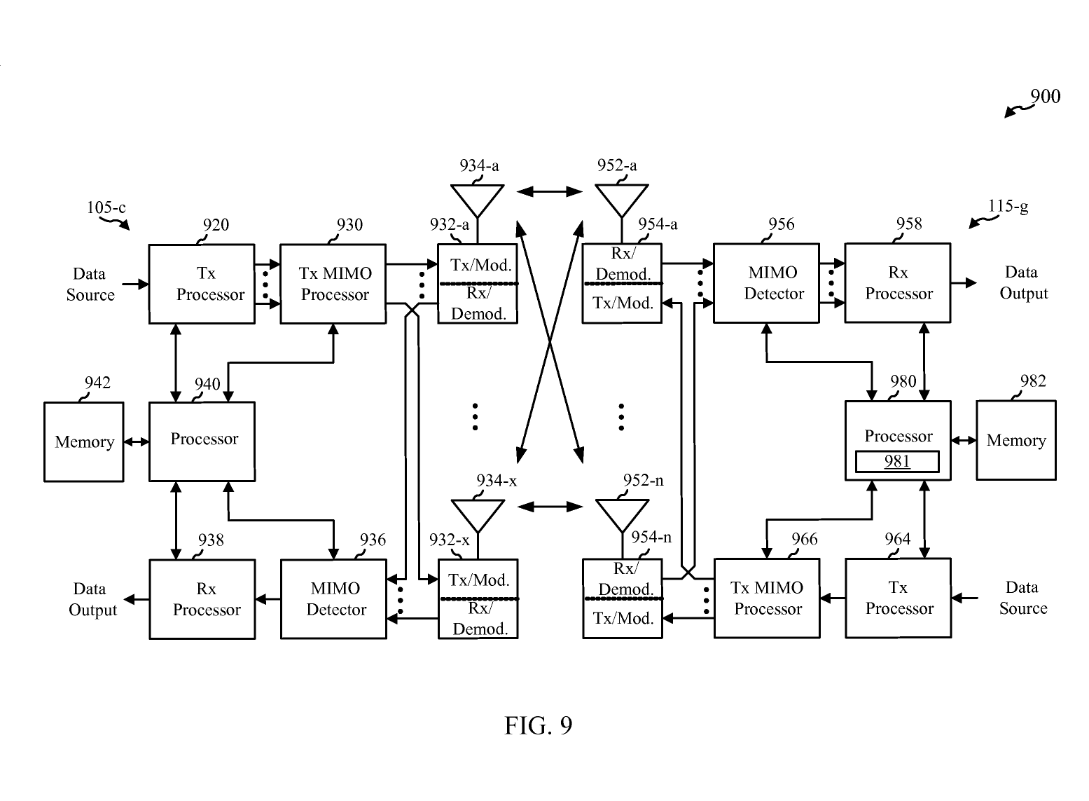

FIG. 9 is a block diagram of a multiple input/multiple output (MIMO) communication system 900 including a base station 105-c and a UE 115-g. The MIMO communications system 900 may illustrate aspects of the wireless communications systems 100 and/or 200 shown in FIGS. 1 and/or 2. The base station 105-c may be equipped with antennas 934-a through 934-x, and the UE 115-g may be equipped with antennas 952-a through 952-n. In the MIMO communications system 900, the base station 105-c may be able to send data over multiple communication links at the same time. Each communication link may be called a “layer” and the “rank” of the communication link may indicate the number of layers used for communication. For example, in a 2×2 MIMO communications system where base station 105-c transmits two “layers,” the rank of the communication link between the base station 105-c and the UE 115-g is two.

At the base station 105-c, a transmit processor 920 may receive data from a data source. The transmit processor 920 may process the data. The transmit processor 920 may also generate control symbols and/or reference symbols. A transmit (TX) MIMO processor 930 may perform spatial processing (e.g., precoding) on data symbols, control symbols, and/or reference symbols, if applicable, and may provide output symbol streams to the transmit modulators 932-a through 932-x. Each modulator 932 may process a respective output symbol stream (e.g., for OFDM, etc.) to obtain an output sample stream. Each modulator 932 may further process (e.g., convert to analog, amplify, filter, and upconvert) the output sample stream to obtain a DL signal. In one example, DL signals from modulators 932-a through 932-x may be transmitted via the antennas 934-a through 934-x, respectively.

At the UE 115-g, the UE antennas 952-a through 952-n may receive the DL signals from the base station 105-c and may provide the received signals to the demodulators 954-a through 954-n, respectively. Each demodulator 954 may condition (e.g., filter, amplify, downconvert, and digitize) a respective received signal to obtain input samples. Each demodulator 954 may further process the input samples (e.g., for OFDM, etc.) to obtain received symbols. A MIMO detector 956 may obtain received symbols from all the demodulators 954-a through 954-n, perform MIMO detection on the received symbols, if applicable, and provide detected symbols. A receive processor 958 may process (e.g., demodulate, deinterleave, and decode) the detected symbols, providing decoded data for the UE 115-g to a data output, and provide decoded control information to a processor 980, or memory 982.

The processor 980 may in some cases execute stored instructions to instantiate one or more of a network acquisition coordination module 610 and/or a backup network acquisition module 840 as described above in reference to FIGS. 6, 7, and/or 8.

On the uplink (UL), at the UE 115-g, a transmit processor 964 may receive and process data from a data source. The transmit processor 964 may also generate reference symbols for a reference signal. The symbols from the transmit processor 964 may be precoded by a transmit MIMO processor 966 if applicable, further processed by the demodulators 954-a through 954-n (e.g., for SC-FDMA, etc.), and be transmitted to the base station 105-c in accordance with the transmission parameters received from the base station 105-c. At the base station 105-c, the UL signals from the UE 115-g may be received by the antennas 934, processed by the demodulators 932, detected by a MIMO detector 936 if applicable, and further processed by a receive processor 938. The receive processor 938 may provide decoded data to a data output and to the processor 940 and/or memory 942.

The components of the UE 115-g may, individually or collectively, be implemented with one or more ASICs adapted to perform some or all of the applicable functions in hardware. Each of the noted modules may be a means for performing one or more functions related to operation of the MIMO communications system 900. Similarly, the components of the base station 105-c may, individually or collectively, be implemented with one or more ASICs adapted to perform some or all of the applicable functions in hardware. Each of the noted components may be a means for performing one or more functions related to operation of the MIMO communications system 900.

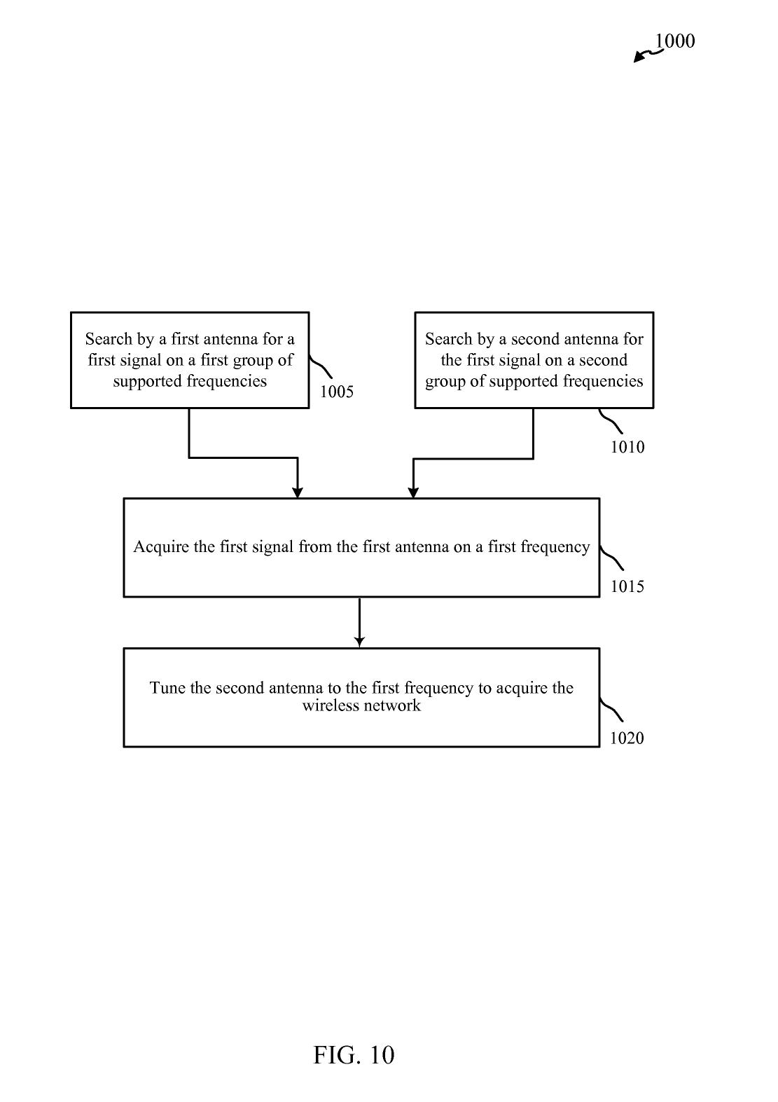

FIG. 10 is a flow chart illustrating an example of a method 1000 for concurrently scanning for a network signal on multiple frequencies using multiple antennas, in accordance with various aspects of the present disclosure. For clarity, the method 1000 is described below with reference to aspects of one or more of the UEs 115 described with reference to FIGS. 1, 2, 4, 5, 6, 7, 8, and/or 9. In some examples, a UE 115 may execute one or more sets of codes to control the functional elements of the UE 115 to perform the functions described below. Additionally or alternatively, the UE 115 may perform one or more of the functions described below using special-purpose hardware.

At block 1005, the method 1000 may include searching by a first antenna for a first signal on a first group of supported frequencies/frequency bands. Concurrently, the method 1000 may include searching by a second antenna for a first signal on a second group of supported frequencies/frequency bands at block 1010.

The operations at block 1005 and/or 1010 may be performed using the first and second transceivers 605, 615 of FIGS. 6, 7, and/or 8, and/or the antennas 805, 810 of FIG. 8. In some implementations, the network acquisition coordination module 610 may direct or instruct the first and second transceivers 605, 615 to perform the searching.

At block 1015, the method 1000 may include acquiring the first signal from the first antenna on a first frequency. The operations at block 1015 may be performed using the first transceiver 605 of FIGS. 6, 7, and/or 8, and/or the antenna 805 of FIG. 8.

At block 1020, the method 1000 may include tuning the second antenna to the first frequency to acquire the wireless network. The operations at block 1020 may be performed using the second transceiver 605 of FIGS. 6, 7, and/or 8, and/or the antenna 810 of FIG. 8. In some embodiments, the network acquisition coordination module 610 may direct or instruct the second transceiver 615 to tune to the first frequency to aid in acquiring the network.

Thus, the method 1000 may provide for concurrently scanning for a network signal on multiple frequencies using multiple antennas. It should be noted that the method 1000 is just one implementation and that the operations of the method 1000 may be rearranged or otherwise modified such that other implementations are possible.

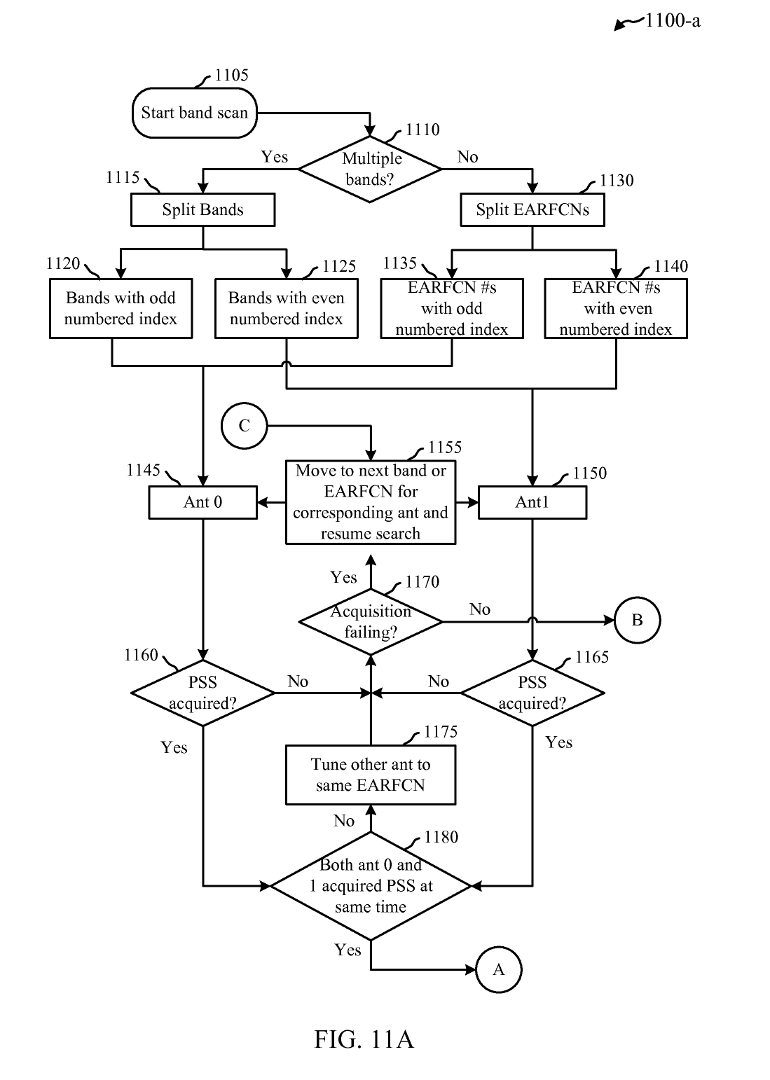

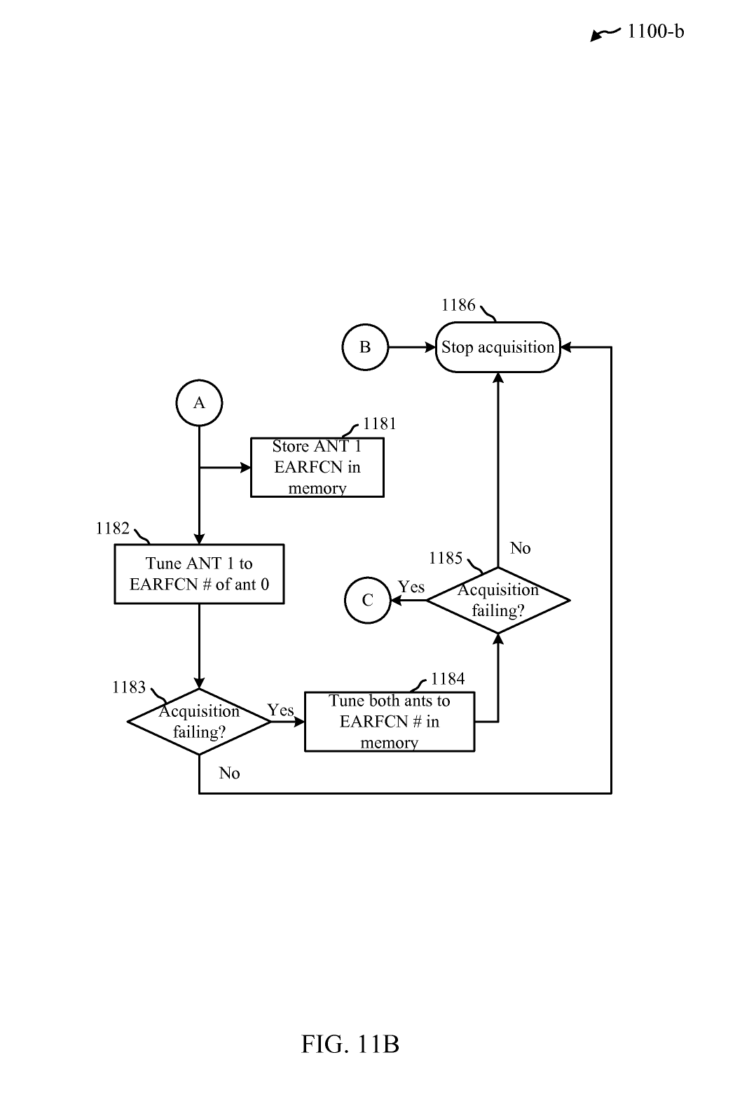

FIGS. 11A and 11B illustrate a single flow chart broken into two parts 1100-a and 1100-b illustrating an example of a method 1100 for concurrently acquiring a network signal by a UE 115 using multiple antennas to scan on multiple frequencies, in accordance with various aspects of the present disclosure. For clarity, the method 1100 is described below with reference to aspects of one or more of the UEs 115 and base stations 105 described with reference to FIGS. 1, 2, 4, 5, 6, 7, and/or 8. In some examples, a UE 115 may execute one or more sets of codes to control the functional elements of the UE 115 to perform the functions described below. Additionally or alternatively, the UE 115 may perform one or more of the functions described below using special-purpose hardware.

In one example, the method or process 1100 may begin with a UE 115 starting a band scan at block 1105. The UE 115 may determine if multiple frequency bands are supported by the UE 115 at block 1110. If multiple bands are supported, the UE 115 may then split or divide the bands at block 1115 into two groups, for example, with one group of frequency bands containing odd numbered index values at block 1120, and the other group containing frequency bands with even numbered index values at block 1125 (e.g., based on frequency index 300-a of FIG. 3A). The UE 115 may then assign the bands with odd index values to antenna 0 (ANT 0) and the bands with even index values to antenna 1 (ANT 1).

If the UE 115 determines that only one frequency band is supported at block 1110, the UE 115 may then split the EARFCNs at block 1130 into EARFCNs with odd index values at block 1135 and EARFCNs with even index values at block 1140 (e.g., based on frequency index 300-b of FIG. 3B). The UE 115 may then assign the EARFCNs with odd index values to ANT 0 and the EARFCNs with even index values to ANT 1.

In either scenario, ANT 0 and ANT 1 may then search the assigned frequencies (EARFCNs)/frequency bands at blocks 1145, 1150 and periodically, or upon detection of a signal, etc., determine if a Primary Synchronization Signal (PSS) has been acquired at blocks 1160, 1165. If no PSS is acquired at blocks 1160, 1165, the UE 115 may further determine if acquisition is failing at block 1170. If acquisition is failing at block 1170, the UE 115 assigns the next EARFCN/frequency band corresponding to the groups determined at blocks 1120, 1125 or 1135, 1140 to each antenna at block 1155, and ANT 0 and ANT 1 may continue scanning at blocks 1145, 1150. In this scenario, acquisition may usually fail as both ANT 0 and ANT are searching at blocks 1145, 1150 for a PSS, but have not acquired the signal.

The UE 115 may continue searching on additional EARCFNs/frequency bands by ANT 0 and ANT 1 at blocks 1145, 1150 until a PSS is acquired at one or both of blocks 1160, 1165. The UE 115 may subsequently determine if both ANT 0 and ANT 1 acquired a PSS at the same time at block 1180. If it is determined that only one antenna, ANT 0 or ANT 1, acquired the PSS at block 1180, then the UE 115 may tune the other antenna to the same EARFCN to act as diversity for better signal reception at block 1175. If acquisition is successful, such that the UE 115 determines that acquisition is not failing at block 1170, the method 1100 may end at block 1186, resulting in a successful acquisition. However, if the acquisition is failing at block 1170, the UE 115 may then instruct ANT 0 and ANT 1 to scan on the next EARFCN/frequency band at blocks 1155, 1145, 1150 and the method 1100 may continue to loop through blocks 1160, 1165, 1170, 1155, and back to blocks 1145, 1150 until a PSS is acquired.

If the UE 115 determines that both ANT 0 and ANT 1 acquired a PSS at the same time at block 1180, the UE 115 may store the EARFCN acquired by or ANT 1 (or in another embodiment, ANT 0) in memory at block 1181 and tune ANT 1 to the EARFCN resulting in PSS acquisition by ANT 0, for example, to act as diversity to aid in better signal reception. If acquisition does not fail at block 1183, the acquisition method 1100 may end at block 1186, resulting in a successful acquisition. However, if acquisition is failing at block 1183, the UE 115 may retrieve the EARFCN used to scan by ANT 1, tune both antennas ANT 0 and ANT 1 to that EARFCN at block 1184, and scan for the PSS. If acquisition is successful at block 1185, the acquisition may end, resulting in a successful acquisition. However, if the acquisition fails at block 1185, the method 1100 may return to block 1155, where the subsequent EARFCNs/frequency bands corresponding to groups determined at blocks 1120, 1125 or 1135, 1140 may be scanned by ANT 0 and ANT 1 at blocks 1145, 1150.

In some examples, aspects of both of the methods 1000 and 1100 may be combined. It should be noted that the methods 1000 and 1100 are just example implementations, and that the operations of methods 1000, 1100 may be rearranged or otherwise modified such that other implementations are possible.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (WiFi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over an unlicensed and/or shared bandwidth. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of acquiring a wireless network by a user equipment (UE), comprising:
searching with a first antenna for a first signal on a first group of supported frequencies while concurrently searching with a second antenna for the first signal on a second group of supported frequencies;
acquiring the first signal from the first antenna on a first frequency; and
tuning the second antenna to the first frequency to acquire the wireless network.

2. The method of claim 1, further comprising:
acquiring the first signal from the second antenna on a second frequency; and
storing the second frequency in a memory of the UE.

3. The method of claim 2, further comprising:
accessing the second frequency from the memory of the UE; and
tuning both the first antenna and the second antenna to the second frequency to acquire the wireless network when acquisition on the first frequency fails.

4. The method of claim 2, wherein acquiring the first signal from the first antenna is performed concurrently with acquiring the first signal from the second antenna.

5. The method of claim 1, wherein the first and second groups of supported frequencies represent frequencies within a single frequency band.

6. The method of claim 1, wherein the first and second groups of supported frequencies represent first and second groups of frequency bands.

7. The method of claim 1, further comprising:
indexing a plurality of supported frequencies;
assigning a first portion of the indexed frequencies to the first group of supported frequencies; and
assigning a second portion of the indexed frequencies to the second group of supported frequencies.

8. The method of claim 7, wherein assigning the first and the second portions of the indexed frequencies to the first group of supported frequencies and the second group of supported frequencies is based on at least one of random selection, the indexing of the frequencies, frequency characteristics, or a combination thereof.

9. The method of claim 1, wherein the first signal includes a Primary Synchronization Signal (PSS).

10. The method of claim 1, wherein the first frequency comprises an Evolved Universal Terrestrial Radio Access (EUTRA) Absolute Radio Frequency Channel Number (EARFCN).

11. The method of claim 1, further comprising:
dividing a plurality of supported frequencies into a plurality of groups; and
searching each of the plurality of groups by a corresponding antenna.

12. A user equipment (UE) apparatus for wireless communication, comprising:
means for searching with a first antenna for a first signal on a first group of supported frequencies while concurrently searching with a second antenna for the first signal on a second group of supported frequencies;
means for acquiring the first signal from the first antenna on a first frequency; and
means for tuning the second antenna to the first frequency to acquire a wireless network.

13. The apparatus of claim 12, further comprising:
means for acquiring the first signal from the second antenna on a second frequency; and
means for storing the second frequency in a memory of the UE.

14. The apparatus of claim 13, further comprising:
means for accessing the second frequency from the memory of the UE; and
means for tuning both the first antenna and the second antenna to the second frequency to acquire the wireless network when acquisition on the first frequency fails.

15. The apparatus of claim 13, wherein the means for acquiring the first signal from the first antenna and the means for acquiring the first signal from the second antenna include means for concurrent acquisition.

16. The apparatus of claim 12, wherein the first and second groups of supported frequencies represent frequencies within a single frequency band.

17. The apparatus of claim 12, wherein the first and second groups of supported frequencies represent first and second groups of frequency bands.

18. The apparatus of claim 12, further comprising:
means for indexing a plurality of supported frequencies;
means for assigning a first portion of the indexed frequencies to the first group of supported frequencies; and
means for assigning a second portion of the indexed frequencies to the second group of supported frequencies.

19. The apparatus of claim 18, wherein the means for assigning the first and the second portions of the indexed frequencies to the first group of supported frequencies and the second group of supported frequencies is based on at least one of random selection, the indexing of the frequencies, frequency characteristics, or a combination thereof.

20. A user equipment (UE) apparatus for wireless communication, comprising:
a processor;
memory in electronic communication with the processor; and
instructions stored in the memory, the instructions being executable by the processor to:
search with a first antenna for a first signal on a first group of supported frequencies while concurrently searching with a second antenna for the first signal on a second group of supported frequencies;
acquire the first signal from the first antenna on a first frequency; and
tune the second antenna to the first frequency to acquire a wireless network.

21. The apparatus of claim 20, wherein the instructions stored in the memory are further executable by the processor to:
acquire the first signal from the second antenna on a second frequency; and
store the second frequency in the memory.

22. The apparatus of claim 21, wherein the instructions stored in the memory are further executable by the processor to:
access the second frequency from the memory; and
tune both the first antenna and the second antenna to the second frequency to acquire the wireless network when acquisition on the first frequency fails.

23. The apparatus of claim 21, wherein the instructions for acquiring the first signal from the first antenna include instructions for performing the acquisition concurrently with acquiring the first signal from the second antenna.

24. The apparatus of claim 20, wherein the instructions stored in the memory are further executable by the processor to:
index a plurality of supported frequencies;
assign a first portion of the indexed frequencies to the first group of supported frequencies; and
assign a second portion of the indexed frequencies to the second group of supported frequencies.

25. The apparatus of claim 24, wherein the instructions for assigning the first and the second portions of the indexed frequencies to the first group of supported frequencies and the second group of supported frequencies are based on at least one of random selection, the indexing of the frequencies, frequency characteristics, or a combination thereof.

26. A non-transitory computer-readable medium storing computer-executable code for wireless communication, the code executable by a processor to:
search, with a first antenna of a user equipment (UE), for a first signal on a first group of supported frequencies while concurrently searching with a second antenna for the first signal on a second group of supported frequencies;
acquire the first signal from the first antenna on a first frequency; and
tune the second antenna to the first frequency to acquire a wireless network.

27. The non-transitory computer-readable medium of claim 26, wherein the code is further executable by a processor to:
acquire the first signal from the second antenna on a second frequency; and
store the second frequency in a memory of the UE.

28. The non-transitory computer-readable medium of claim 27, wherein the code is further executable by a processor to:
access the second frequency from the memory; and
tune both the first antenna and the second antenna to the second frequency to acquire the wireless network when acquisition on the first frequency fails.

29. The non-transitory computer-readable medium of claim 26, wherein the code is further executable by a processor to:
index a plurality of supported frequencies;
assign a first portion of the indexed frequencies to the first group of supported frequencies; and
assign a second portion of the indexed frequencies to the second group of supported frequencies.

30. The non-transitory computer-readable medium of claim 29, wherein the code for assigning the first and the second portions of the indexed frequencies to the first group of supported frequencies and the second group of supported frequencies is based on at least one of random selection, the indexing of the frequencies, frequency characteristics, or a combination thereof.
